(19) United States
(12) Patent Application Publication
(10) Pub. No.: US 2008/0232245 A1
(43) Pub. Date: Sep. 25, 2008

(54) Transmission apparatus

(75) Inventors: Takayuki Furukawa, Fukuoka (JP); Kenichi Ohyama, Fukuoka (JP); Katsuyuki Okabe, Fukuoka (JP); Noboru Kamei, Fukuoka (JP)

Correspondence Address: HANIFY & KING PROFESSIONAL CORPORATION, 1875 K STREET, NW, SUITE 707, WASHINGTON, DC, 20006, US

(73) Assignee: FUJITSU LIMITED

(21) Appl. No.: 12/073,623

(22) Filed: Mar. 7, 2008

(30) Foreign Application Priority Data
Mar. 20, 2007 (JP) 2007-072201

(51) Int. Cl. G06F 11/00

(52) U.S. Cl. 370/221

(57) ABSTRACT

A transmission apparatus includes an active programmable device; a standby programmable device upgrading the version; an external memory part that includes a table memory and a main signal memory and that is shared between the two programmable devices; and a switching part that selects either of the main signals processed by the two programmable devices to transmit the selected main signal to an output path. The active programmable device is capable of processing the main signals in parallel with the standby programmable device and receives a notification of completion of the version upgrade from the standby programmable device to issue an instruction to start switching to the standby programmable device. The standby programmable device uses the table memory and the main signal memory updated by the active programmable device to process the main signals in response to the instruction to start the switching.

### BACKGROUND OF THE INVENTION

1. Field of the Invention

The present invention relates to transmission apparatuses capable of terminating main signals (frames or packets) and, more particularly, to a transmission apparatus upgrading the version of a programmable device provided for processing of main signals.

2. Description of the Related Art

Transmission apparatuses, such as relay apparatuses, used over communication networks process main signals with programmable devices, such as field programmable gate arrays (FPGAs) or complex programmable logic devices (CPLDs). The transmission apparatuses store various tables necessary to process the main signals and the main signals in external storage apparatuses.

The apparatuses of this kind upgrade the versions of the programmable devices if the specifications are changed or any failure occurs. A method of upgrading the version of a programmable device in related art will now be described simply with reference to FIGS. 9 to 16.

FIG. 9 illustrates a first upgrade method in the related art when each transmission apparatus includes one programmable device. Referring to FIG. 9, a transmission apparatus 20 is arranged at the upstream side of the transmission direction of main signals and a transmission apparatus 21 is arranged at the downstream side thereof. The upstream transmission apparatuses 20 and 21 each include a programmable device 22 and an external memory group 23.

When the downstream transmission apparatus 21 in FIG. 9 upgrades the version of the programmable device 22, the downstream transmission apparatus 21 performs signaling 25 to the upstream transmission apparatus 20 in order to stop transmission of the main signals. The transmission apparatus 21 upgrades the programmable device 22 after the transmission of the main signals to the downstream transmission apparatus 21 is stopped. The signaling 25 includes a pause frame defined in Institute of Electrical and Electronic Engineers (IEEE) 802.3x.

FIG. 10 illustrates a second upgrade method in the related art when a transmission apparatus includes one programmable device. A transmission apparatus 30 in FIG. 10 includes a programmable device 31, an external memory group 32, and an external memory device 33 arranged at the input side of the programmable device 31. A main signal through a transmission path is supplied to the programmable device 31 through the external memory device 33.

When the transmission apparatus 30 in FIG. 10 upgrades the version of the programmable device 31, a suppression signal 34 is supplied from the programmable device 31 to the external memory device 33. The transmission apparatus 30 upgrades the version of the programmable device 31 in a state in which the main signals supplied through the transmission path are queued in the external memory device 33. After the upgrade of the programmable device 31 is completed, the transmission apparatus 30 stops the suppression signal 34 and restarts the processing of the main signals stored in the external memory device 33.

As described above, since it is not possible for the programmable device to process the main signals during the version upgrade of the programmable device in the transmission apparatus including one programmable device, the supply of the main signal can be stopped. Since the main signals are queued until the version upgrade is completed, transmission delay can occur for a time corresponding to the time necessary to upgrade the version of the programmable device although any loss of the main signals does not occur. The time necessary to upgrade the version of the current programmable devices, for example, the configuration time of FPGAs, is on the order of several seconds. The methods in which the main signals are queued have a problem in that the number of stored frames is increased and longer transmission delay can occur.

In a typical transmission apparatus in the related art, multiple programmable devices for the version upgrade are provided, as in examples shown in FIGS. 11 to 16, to avoid the supply of the main signals from being stopped during the version upgrade and to prevent any transmission delay. For example, the apparatus disclosed in Japanese Unexamined Patent Application Publication No. 2000-174844 includes multiple programmable devices having different circuit configurations. If any failure occurs, switching to the appropriate programmable device allows the version to be upgraded without interrupting the communication.

FIGS. 11 to 16 illustrate an upgrade method in the related art when a transmission apparatus includes two programmable devices. A transmission apparatus 40 shown in each of FIGS. 11 to 16 includes programmable devices 41 and 43 to which main signals are supplied in parallel, an external memory group 42 used by the programmable device 41, an external memory group 44 used by the programmable device 43, and a selection switch (SW) 45 selecting either an output from the programmable device 41 or an output from the programmable device 43 to transmit the selected output to an output path. In additions, a circuit information random access memory (RAM) 46 storing circuit information for the version upgrade is connected in parallel to the programmable devices 41 and 43.

FIG. 11 illustrates an operational state of the transmission apparatus 40 before the version upgrade. As shown in FIG. 11, the programmable device 41 and the external memory group 42 are active devices that generate main signals to be supplied to the output path, and the programmable device 43 and the external memory group 44 are standby devices that perform the version upgrade. The active programmable device 41 uses the external memory group 42 to process the main signals. The programmable device 43 uses the external memory group 44 to process the main signals. The selection switch 45 selects the output from the active programmable device 41.

FIG. 12 illustrates an operational state of the transmission apparatus 40 when the active side processes the main signals. In the transmission apparatus 40 shown in FIG. 12, the circuit information RAM 46 supplies the circuit information to the standby programmable device 43 to upgrade the version of the programmable device 43. When the version upgrade is completed (FIG. 13), the standby programmable device 43 starts processing of the main signals (FIG. 14). The selection switch 45 selects the output from the active programmable device 41 until the main signals (frames) supplied through the transmission path circulate through the standby programmable device 43.

Specifically, as shown in FIG. 15, the selection switch 45 selects the output from the standby programmable device 43 after the main signals (frames) supplied through the transmission path circulate through the standby programmable device 43 and the frame output from the active programmable device 41 is in phase with the frame output from the standby programmable device 43.

Subsequently, as shown in FIG. 16, the programmable device 43 and the external memory group 44 are switched to the active side and the programmable device 41 and the external memory group 42 are switched to the standby side. The active programmable device 43 uses the external memory group 44 to continue to process the main signals. The standby programmable device 41 uses the external memory group 42 to process the main signals. The selection switch 45 selects the output from the active programmable device 43.

However, it is not possible to perform non-stop version upgrade by the version upgrade method shown in FIGS. 11 to 16. The reason for the disablement of the non-stop version upgrade is described with reference to FIGS. 17 and 18. FIG. 17 illustrates the relationship between the active side and the standby side when the processing of the main signals is switched from the active side to the standby side as in the example shown in FIG. 15. FIG. 18 illustrates an operation for copying the content of the external memories from the active side to the standby side when the processing of the main signals is switched from the active side to the standby side as in the example shown in FIG. 15.

Referring to FIG. 17, since the content of the active external memory group 42 is different from that of the standby external memory group 44, it is not possible to normally continue the communication by the method in which the selection switch 45 switches the selection from the active programmable device 41 to the standby programmable device 43 that has completed the version upgrade at a time when the frames circulate through the standby programmable device 43 and the frame output from the active programmable device 41 is in phase with the frame output from the standby programmable device 43.

For example, if the bandwidth of the output path is narrower than that of the input path, the frames are held in the main signal memory in the active external memory group 42 when the active side is operated. In such a case, since the frame output from the programmable device 41 is not in phase with the frame output from the programmable device 43, it is not possible for the selection switch 45 to perform the switching, thus stopping the supply of the main signals. In order to avoid the stop of the supply of the main signals, it is necessary to notify the programmable device 43 that has completed the version upgrade of the number of held frames.

In addition, if the programmable device 43 that has completed the version upgrade is not notified of the content of update when the routing table in the active external memory group 42 is updated according to Routing Information Protocol (RIP) (protocol used for transmitting path information between transmission apparatuses on Layer 3), the selection switch 45 determines that the frames circulate through the standby programmable device 43 and the frame output from the active programmable device 41 is in phase with the frame output from the standby programmable device 43 and switches the selection from the active programmable device 41 to the standby programmable device 43 that has completed the version upgrade, thus transmitting the frames to the wrong output path.

In order to take over the state of the active side to the standby side, a method shown in FIG. 18 is proposed in which the content of the active external memory group 42 is copied 48 to the standby external memory group 44 in the switching of the selection from the active side to the standby side.

However, the transmission apparatus 40 in the related art includes the separate external memory groups 42 and 44 for the two programmable devices 41 and 43, for example, as shown in FIG. 11. Accordingly, in order to completely take over the state of the active side to the standby side, it is also necessary to copy the internal state of the active programmable device 41 to the standby programmable device 43, in addition to the copying 48 of the content of the active external memory group 42 to the standby external memory group 44 that has completed the version upgrade. Consequently, the method shown in FIG. 18 is not sufficient.

In addition, since it takes a certain time to perform the copying, the standby side cannot address any change in the state of the active side, which is caused by the frames received by the active side during the copying.

### SUMMARY OF THE INVENTION

According to an embodiment of the present invention, a transmission apparatus terminating frames or packets, which are main signals supplied through a transmission path, includes an active programmable device processing the main signals; a standby programmable device upgrading the version; an external memory part that includes a table memory storing various search tables necessary for the two active and standby programmable devices to process the main signals and a main signal memory storing the main signals and that is shared between the two programmable devices; and a switching part that selects the main signal processed by the active programmable device before the version upgrade and selects the main signal processed by the standby programmable device after the version upgrade to transmit the selected main signal to an output path. The active programmable device is capable of processing the main signals in parallel with the main signals processed by the standby programmable device, and receives a notification of completion of the version upgrade from the standby programmable device to issue an instruction to start switching to the standby programmable device. The standby programmable device uses the table memory and the main signal memory in the external memory part, updated by the active programmable device, to process the main signals in response to the instruction to start the switching from the active programmable device.

### BRIEF DESCRIPTION OF THE DRAWINGS

FIG. 1 is an exemplary block diagram showing the basic configuration of a transmission apparatus;

FIG. 2 is a block diagram showing an example of the configuration of the transmission apparatus;

FIG. 3 illustrates an example of an operational state of the transmission apparatus shown in FIG. 2 before a version upgrade is performed;

FIG. 4 illustrates an example of an operation of upgrading the version of the standby side during the frame processing at the active side shown in FIG. 3;

FIG. 5 illustrates an example of an operation for starting the frame processing at the standby side that has completed the version upgrade operation shown in FIG. 4;

FIG. 6 illustrates an example of a transient operation before the frame processing is switched from the active side to the standby side after the standby side starts the frame processing;

FIG. 7 illustrates an example of a time when the frame processing is switched from the active side to the standby side in the transient state shown in FIG. 6;

FIG. 8 illustrates an example of an operation in which the active side is switched to the standby side that performs non-stop continuation of the frame processing;

FIG. 9 illustrates a first upgrade method in related art when each transmission apparatus includes one programmable device;

FIG. 10 illustrates a second upgrade method in the related art when a transmission apparatus includes one programmable device;

FIG. 11 illustrates an upgrade method in the related art (an operational state of the transmission apparatus before the version upgrade) when a transmission apparatus includes two programmable devices;

FIG. 12 illustrates an operation for upgrading the standby side while the active side shown in FIG. 11 processes main signals;

FIG. 13 illustrates a state in which the version upgrade of the standby side shown in FIG. 12 is completed;

FIG. 14 illustrates an operation for starting the processing of the main signals at the standby side shown in FIG. 13 which completed the version upgrade;

FIG. 15 illustrates an operation for switching the selection from the active side to the standby side after the standby side starts to process the main signals;

FIG. 16 illustrates an operation for continuing the processing of the main signals by the programmable device that has been switched from the standby side to the active side;

FIG. 17 illustrates the relationship between the active and standby sides when the processing of the main signals is switched from the active side to the standby side as shown in FIG. 15; and

FIG. 18 illustrates an operation for copying the content of an external memory from the active side to the standby side when the processing of the main signals is switched from the active side to the standby side as shown in FIG. 15.

### DESCRIPTION OF THE PREFERRED EMBODIMENTS

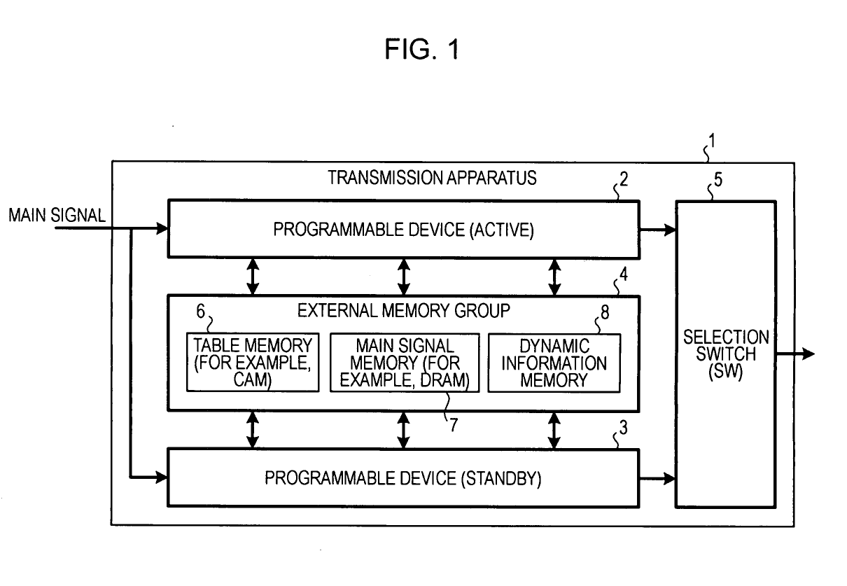

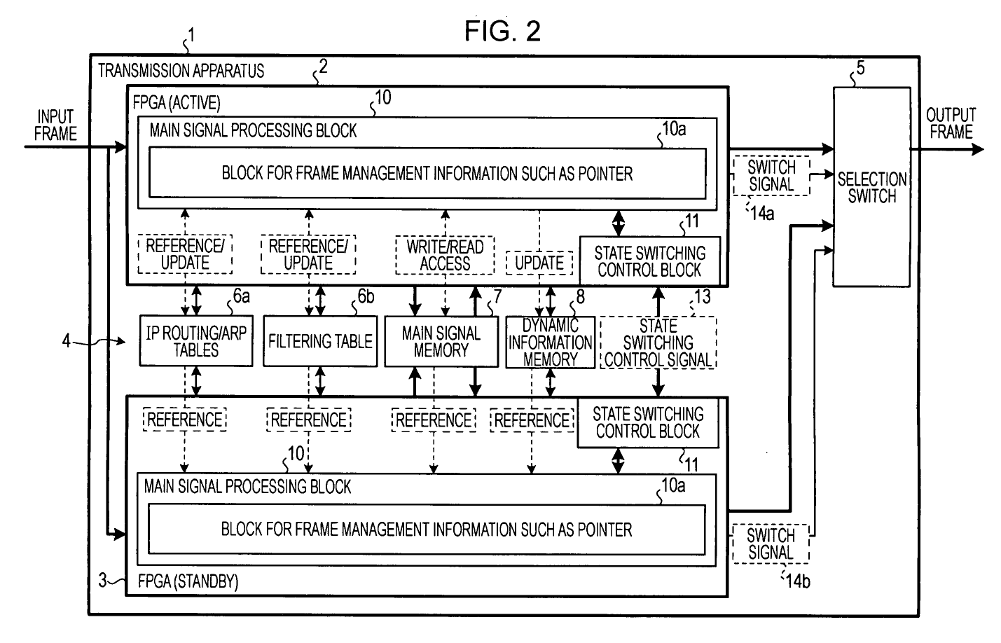

FIG. 1 is an exemplary block diagram showing the basic configuration of a transmission apparatus. FIG. 2 is a block diagram showing an example of the configuration of the transmission apparatus. In order to make it easy to understand these examples, the basic configuration of the transmission apparatus is described with reference to FIG. 1 and, then, an example of the configuration of the transmission apparatus is described with reference to FIG. 2.

As shown in FIG. 1, a transmission apparatus 1 is capable of terminating frames or packets, which are main signals, over a communication network. The transmission apparatus 1 includes programmable devices 2 and 3, an external memory group 4, and a selection switch 5. The main signals are supplied to the programmable devices 2 and 3 in parallel through an input path. The programmable device 2 is capable of performing the same processing as in the programmable device 3. The external memory group 4 is shared between the programmable devices 2 and 3. The selection switch 5 selects either the main signal output from the programmable device 2 or the main signal output from the programmable device 3 to transmit the selected main signal to an output path.

The external memory group 4 includes a table memory 6, a main signal memory 7, and a dynamic information memory 8.

The table memory 6 is, for example, a content addressable memory (CAM) storing various tables (including a message authentication code (MAC) learning table and a routing table).

The main signal memory 7 is, for example, a dynamic RAM (DRAM) storing the main signals.

The dynamic information memory 8 stores dynamic information involved in the reception of the main signals.

The dynamic information includes the memory structure of the main signal memory 7, which varies in processing units of the main signals, that is, for every frame or for every packet, and statistical information including the number of received main signals and the number of discarded main signals.

In the transmission apparatus 1, the programmable device 2 is at the active side actually using the external memory group 4 to process the main signals to be transmitted to the output path. The programmable device 3 is at the standby side waiting for the version upgrade without processing the main signals.

The active programmable device 2 uses the table memory 6 and the main signal memory 7 in the external memory group 4 to process the main signals to be transmitted to the output path. During the processing of the main signals, the programmable device 2 updates the dynamic information memory 8 each time the programmable device 2 processes the processing unit of the main signals. This update operation is continued to a specified last main signal after the version upgrade at the standby side is completed.

The standby programmable device 3 notifies the programmable device 2 of the completion of the version upgrade when the version upgrade is completed. The standby programmable device 3 follows a switching start instruction from the active programmable device 2. The standby programmable device 3 uses the table memory 6 and the main signal memory 7 in the external memory group 4, which are updated by the active programmable device 2, to start the processing of the main signals to be transmitted to the output path. The standby programmable device 3 refers to the dynamic information memory 8 updated by the active programmable device 2 to start the processing of the main signals to be transmitted to the output path.

The selection switch 5 selects the output from the active programmable device 2 in a normal operational state. The selection switch 5 does not switch the selection even if the version upgrade in the standby programmable device 3 is completed. The selection switch 5 selects the output from the standby programmable device 3 when the processing of the last main signal is completed in the active programmable device 2.

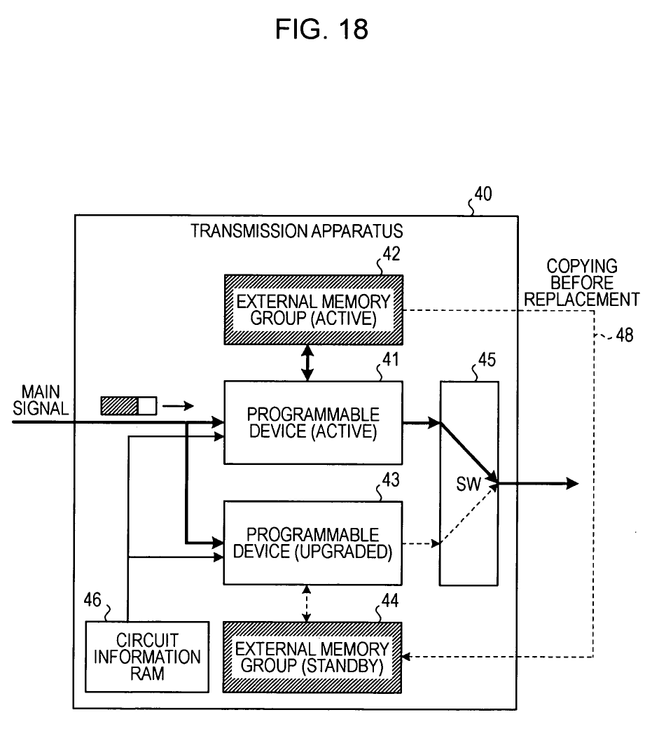

As described above, since the two programmable devices shares the external memory group including the table memory, the main signal memory, and the dynamic information memory in the transmission apparatus, the time necessary for the copying described above with reference to FIG. 18 in the related art does not exist. Accordingly, all the states of the active side including any change in the state of the active side, which have arisen during the version upgrade, can be instantaneously and completely taken over to the standby side. Consequently, it is possible to realize a transmission apparatus capable of a non-stop version upgrade.

An example of the configuration of the transmission apparatus 1 will now be described with reference to FIG. 2. FIG. 2 shows an example of the configuration of a relay apparatus which processes the layers up to Layer 3 in the Open Systems Interconnection (OSI) reference model. The same reference numerals are used in FIG. 2 to identify the same components shown in FIG. 1 for simplicity.

In the transmission apparatus 1 in FIG. 2 having the configuration shown in FIG. 1, the two programmable devices 2 and 3 are, for example, FPGAs. A main signal to be processed is a frame. Accordingly, the frames are stored in the main signal memory 7 in the external memory group 4. In the external memory group 4 in FIG. 2, the table memory 6 is exemplified by an Internet Protocol (IP) routing/address resolution protocol (ARP) tables 6a and a filtering table 6b.

The IP routing table is used in path determination according to the IP used in Layer 3. The ARP table is used to associate the IP address with a media access control address (MAC address), which is a physical address used in Ethernet® frame processing on Layer 2. The filtering table 6b is referred to for Quality of Service (QoS).

A main signal processing block 10 included in each of the programmable devices 2 and 3 analyzes MAC frames or analyzes the protocol of IP packets. The main signal processing block 10 includes a block 10a for frame management information such as pointer.

The block 10a for frame management information such as pointer manages the dynamic information stored in the dynamic information memory 8. The block 10a for frame management information manages the access pointers (read and write pointers) to the main signal memory 7, the memory structures (queue structure and list structure) of the main signal memory 7, the statistical information, such as the number of received frames and the number of discarded frames, necessary for the maintenance, and the dynamic information, such as information in the IP routing table, the ARP table, and the filtering table, varying in units of frames.

The main signal processing block 10 controls the block 10a for frame management information such as pointers to update the dynamic information memory 8 each time one frame is processed. Accordingly, the current dynamic information is stored in the dynamic information memory 8 at any time.

The FPGAs 2 and 3 each include a state switching control block 11. The state switching control block 11 in the FPGA 2 transmits and receives a state switching control signal 13 to and from the state switching control block 11 in the FPGA 3 under the control of the corresponding main signal processing block 10. The state switching control block 11 determines a time when the switching between the active FPGA 2 and the standby FPGA 3 is performed.

The FPGA 2 outputs a switch signals 14a to the selection switch 5 and the FPGA 3 outputs a switch signal 14b to the selection switch 5. The switch signals 14a and 14b are binary level signals capable of being switched between “enable” and “disable”. The selection switch 5 selects the frame output from the FPGA outputting the switch signal set to “enable”, among the switch signals 14a and 14b, and transmits the selected frame to the output path. The selection switch 5 can use a simple space switch and the delay time when the frame passes through the selection switch 5 is set in advance.

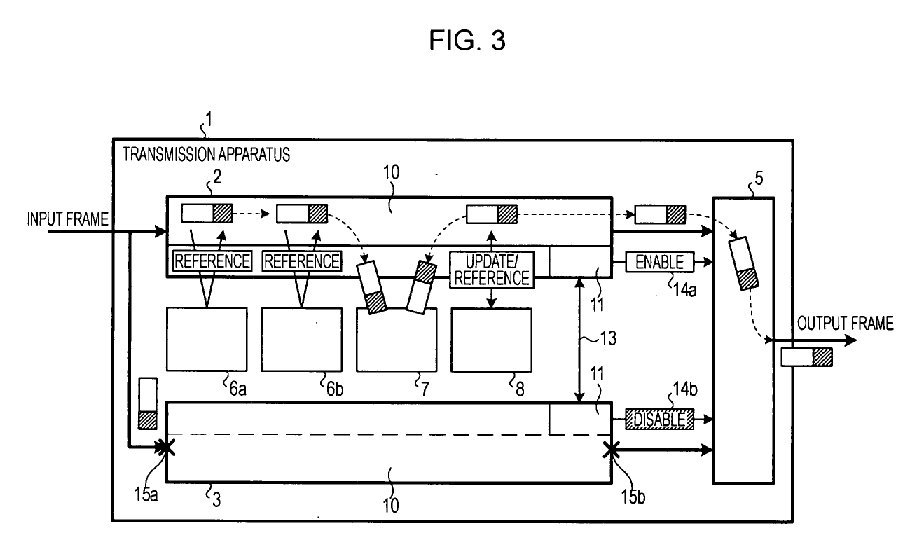

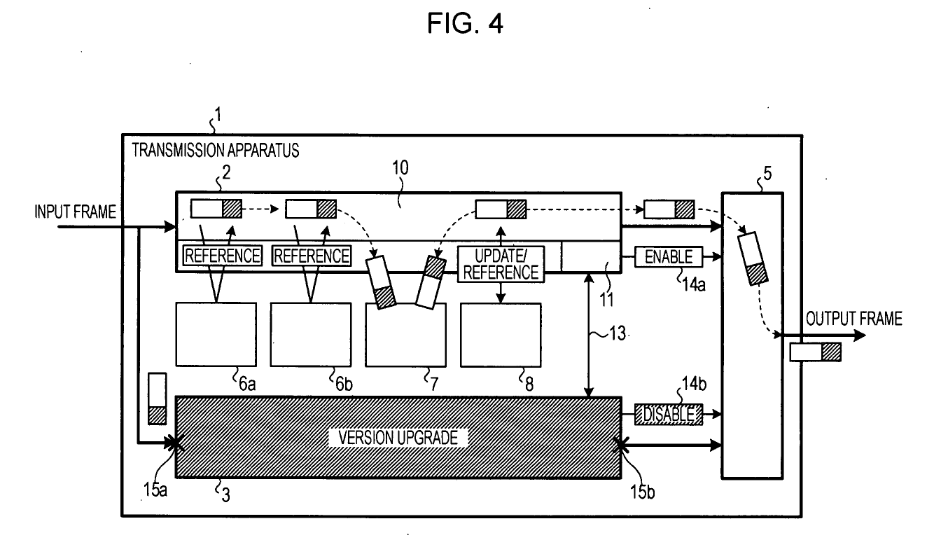

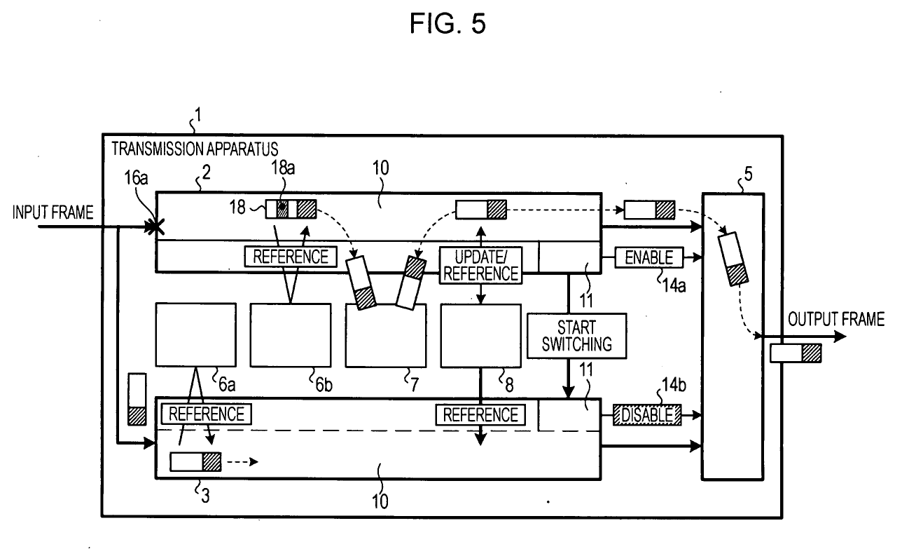

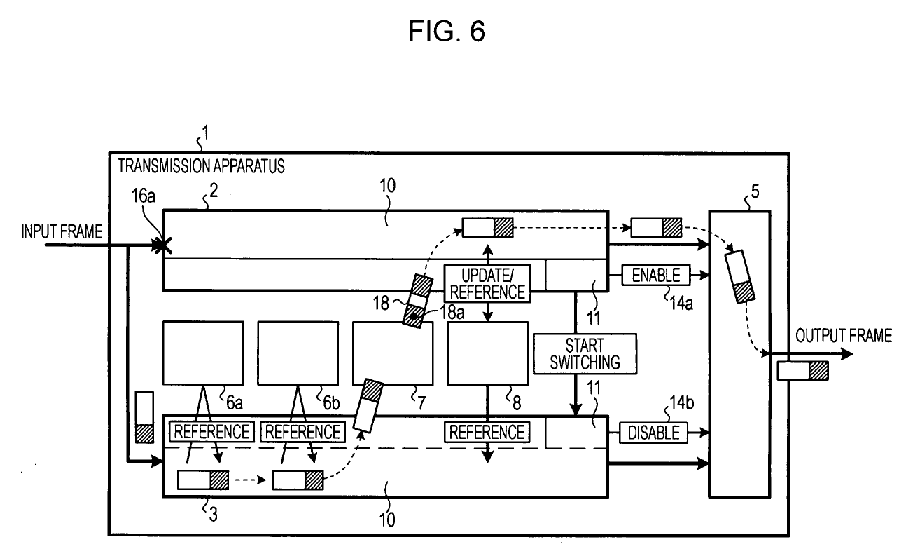

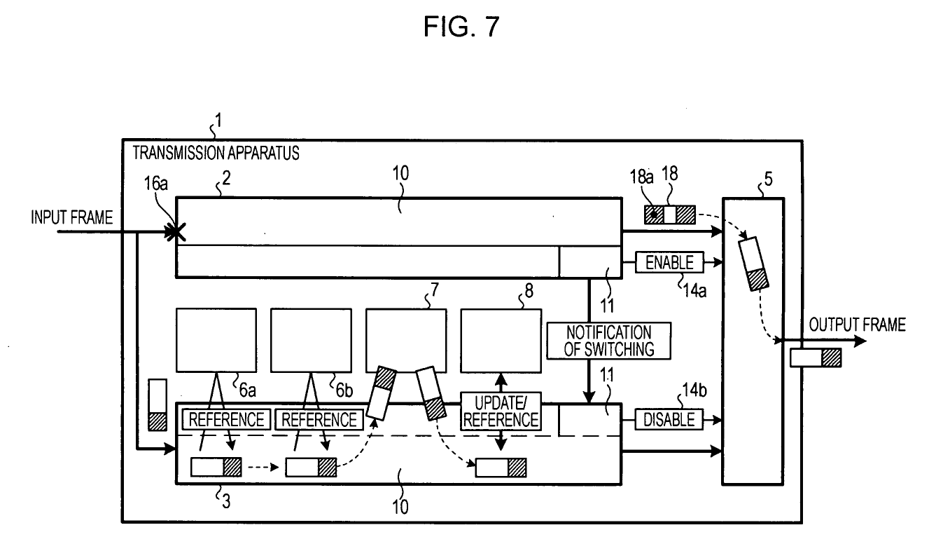

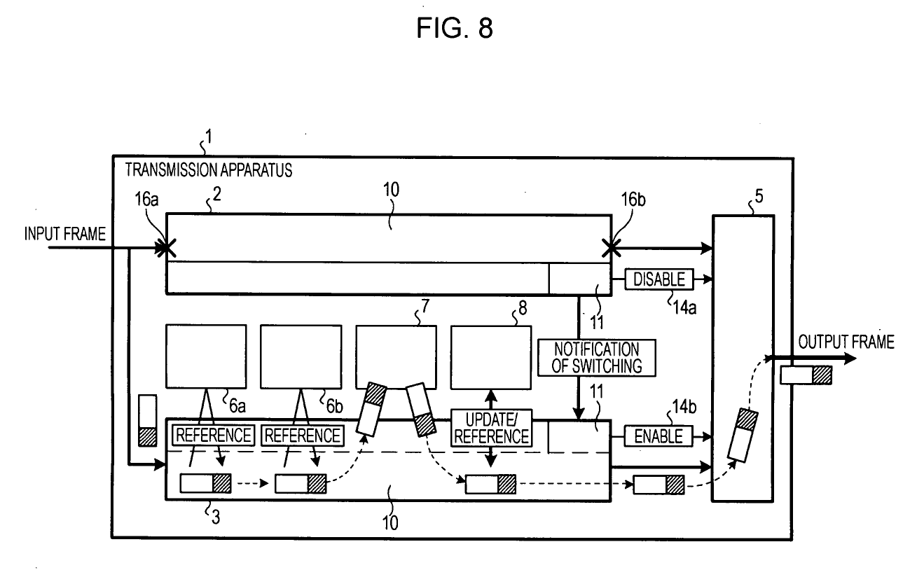

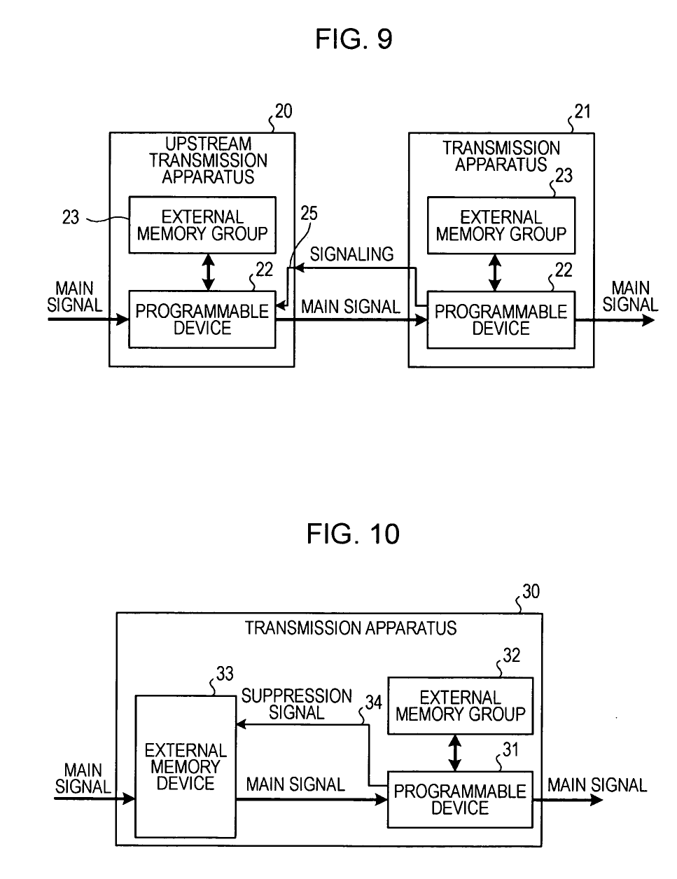

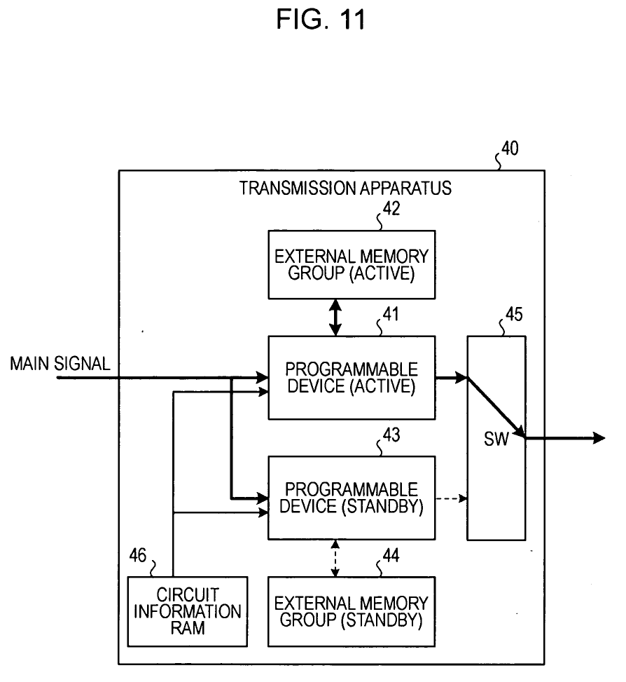

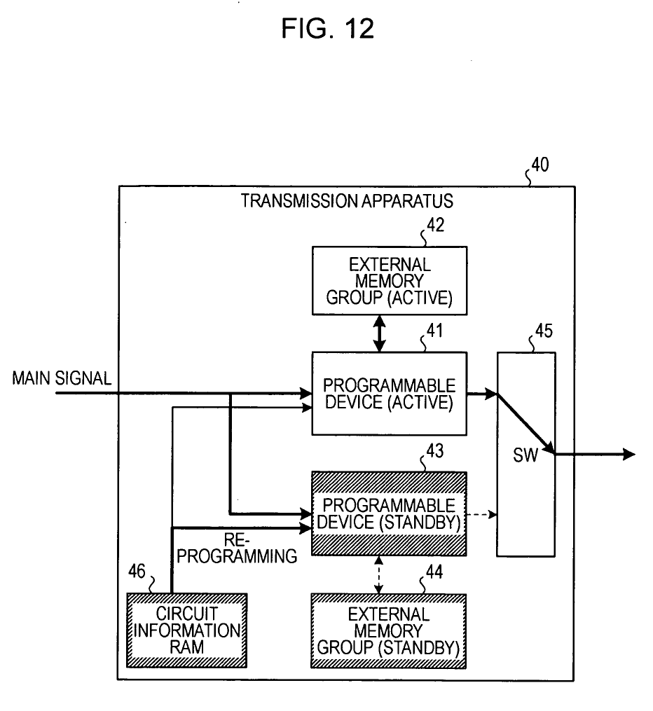

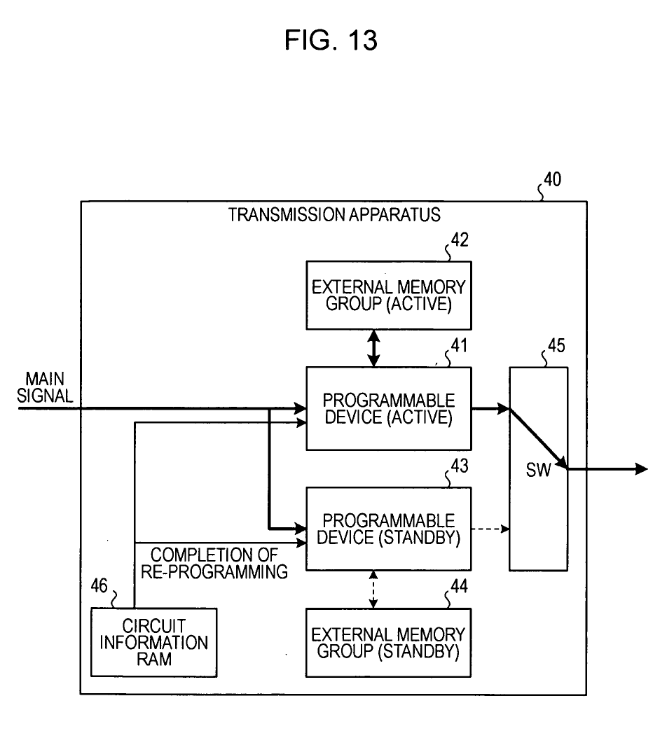

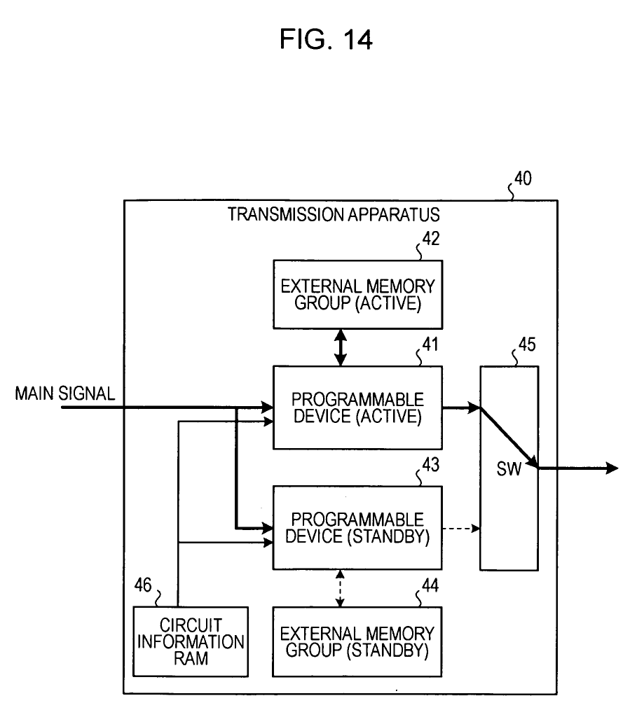

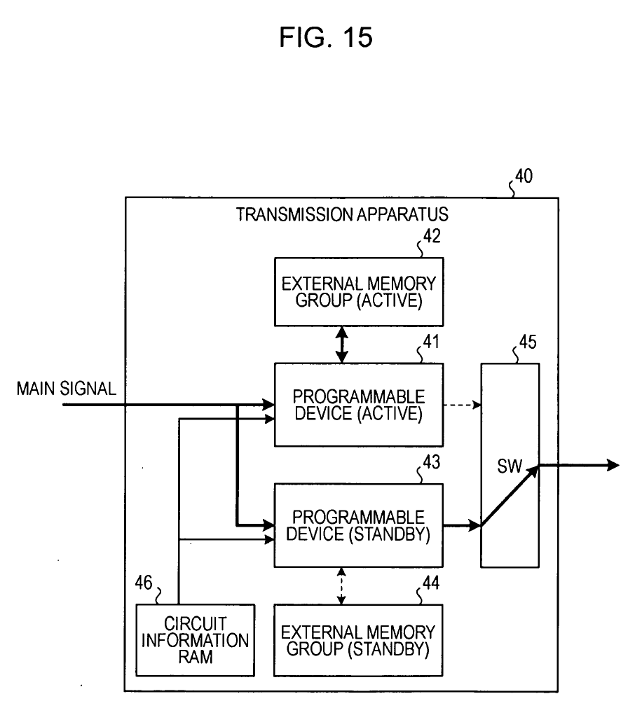

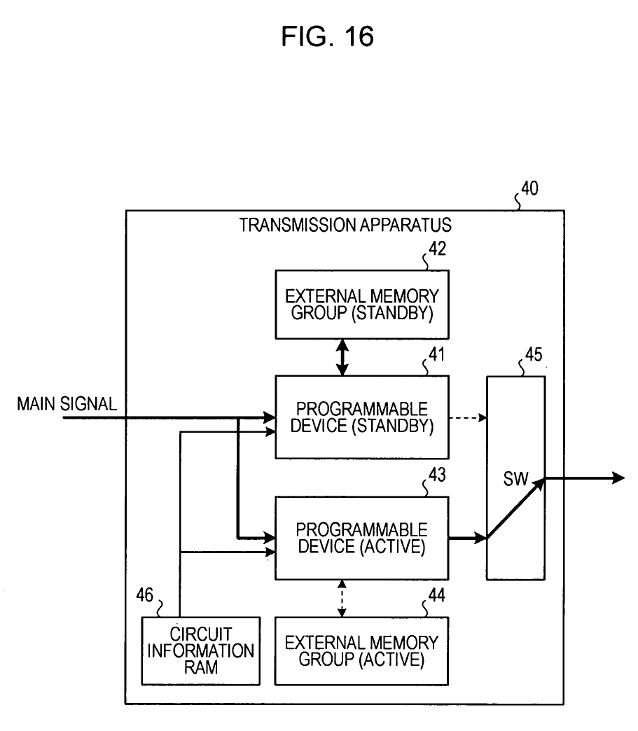

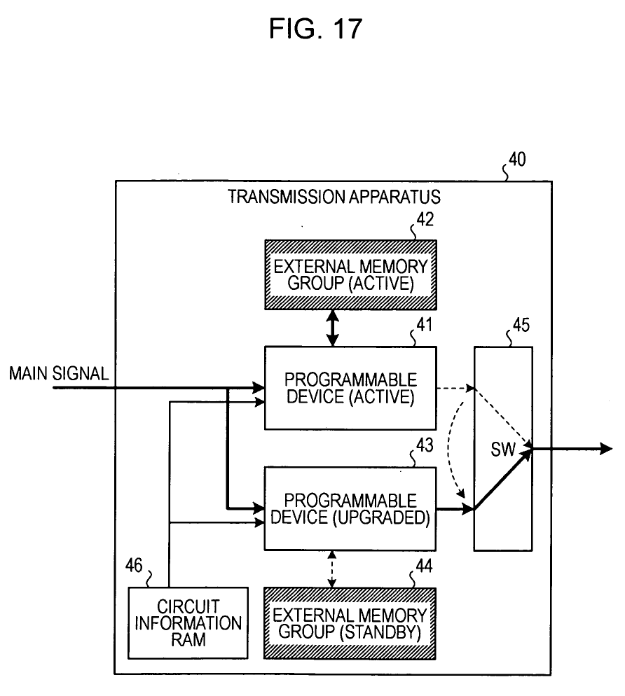

An upgrade method performed in the transmission apparatus shown in FIG. 2 will now be described with reference to FIGS. 3 to 8. FIG. 3 illustrates an operational state of the transmission apparatus before the version upgrade is performed. FIG. 4 illustrates an operation for upgrading the version of the standby side during the frame processing at the active side shown in FIG. 3. FIG. 5 illustrates an operation for starting the frame processing at the standby side that has completed the version upgrade operation shown in FIG. 4. FIG. 6 illustrates a transient operation before the frame processing is switched from the active side to the standby side after the standby side starts the frame processing. FIG. 7 illustrates a time when the frame processing is switched from the active side to the standby side in the transient state shown in FIG. 6. FIG. 8 illustrates an operation in which the active side is switched to the standby side that performs the non-stop continuation of the frame processing.

As shown in FIG. 3, frames input through the input path are supplied to the active FPGA 2 and the standby FPGA 3 in parallel. In the transmission apparatus 1, the switch signal 14a to be supplied from the active FPGA 2 to the selection switch 5 is set to “enable”s in the normal operational state. In contrast, an input port 15a and an output port 15b of the standby FPGA 3 are closed and the switch signal 14b to be supplied from the standby FPGA3 to the selection switch 5 is set to “disable.

The active FPGA 2 refers to the IP routing/ARP tables 6a and the filtering table 6b for every input frame to determine the path and performs processing, such as the filtering. The active FPGA 2 stores and queues the frames in the main signal memory 7. The active FPGA 2 refers to the dynamic information memory 8 each time one frame is read from the main signal memory 7. The active FPGA 2 supplies the read frame to the selection switch 5 while performing the necessary update to the frame.

As shown in FIG. 4, in the version upgrade in the standby FPGA 3, the input port 15a and the output port 15b are closed. The standby FPGA 3 performs the version upgrade with the switch signal 14b to be supplied to the selection switch 5 being set to “disable”. For example, the version upgrade in the standby FPGA 3 is performed with the circuit information RAM 46 being connected thereto. The active FPGA 2 generates the frames to be transmitted to the output path in the above manner.

After the version upgrade in the standby FPGA 3 is completed, as shown in FIG. 5, the standby FPGA 3 uses the state switching control signal 13 to notify the active FPGA 2 of the completion of the version upgrade. The active FPGA 2 receives the notification of the completion of the version upgrade and uses the state switching control signal 13 to instruct the FPGA 3 to start the switching. The active FPGA 2 adds an identifier 18a indicating that the frame is the last frame to a last frame 18. The active FPGA 2 does not process frames subsequent to the last frame 18. The identifier 18a is used to determine that the frame read from the main signal memory 7 is the last frame. Although an input port 16a of the FPGA 3 is closed in FIG. 5, the input port 16a is not necessarily closed because the last frame 18 is specified.

In contrast, the standby FPGA 3 receives the instruction to start the switching and opens the input and output ports with the switch signal 14b to be supplied to the selection switch 5 being kept at “disable”. The standby FPGA 3 receives frames supplied through the input path. The standby FPGA 3 starts to process the frames while referring to the IP routing/ARP tables 6a and the dynamic information memory 8. In other words, the standby FPGA 3 that has completed the version upgrade starts the frame processing from the frame subsequent to the last frame 18 received by the active FPGA 2.

Accordingly, as shown in FIG. 6, before the frame processing is switched from the active side to the standby side, a transient state occurs in which both the active FPGA 2 and the standby FPGA 3 operate. The active FPGA 2 continues the frame processing until the last frame 18 stored in the main signal memory 7 is identified with the identifier 18a and the last frame 18 is supplied to the selection switch 5. The standby FPGA 3 determines the path by referring to the IP routing/ARP tables 6a and the filtering table 6b for every input frame while setting the switch signal 14b to be supplied to the selection switch 5 to “disable”. The standby FPGA 3 performs, for example, the filtering and stores and queues the main signals.

As shown in FIG. 7, the transmission of the last frame 18 from the active FPGA 2 to the selection switch 5 is synchronized with the time when the standby FPGA 3 processes the frame read out from the main signal memory 7 by referring to the dynamic information memory 8 and supplies the processed frame to the selection switch 5. When the active FPGA 2 recognizes the above synchronization on the basis of the-state switching control signal 13, the active FPGA 2 issues a notification of the switching to the standby FPGA 3 with the state switching control signal 13.

As shown in FIG. 8, the active FPGA 2 sets the switch signal 14a to be supplied to the selection switch 5 to “disable” and closes an output port 16b. The standby FPGA 3 receives the notification of the switching and sets the switch signal 14b to be supplied to the selection switch 5 to “enable”.

In response to the enablement of the switch signal 14b, the selection switch 5 switches the selection from the active FPGA 2 to the standby FPGA 3. In other words, after the last frame is transmitted from the active FPGA 2 to the output path, the selection switch 5 then transmits the frames supplied from the standby FPGA 3 to the output path.

Subsequently, the standby FPGA 3 that performed the version upgrade is switched to the active side and the active FPGA 2 is switched to the standby side to continue the operation of the transmission apparatus 1. When the version upgrade is subsequently performed, the version upgrade of the FPGA 2 is performed while the FPGA 3 is active and the active side is switched from the FPGA 3 to the FPGA 2 in the same manner.

As described above, the standby FPGA 3 refers to the dynamic information memory 8 updated by the active FPGA 2 to perform the frame processing during the version upgrade or after the version upgrade. Accordingly, it is possible to prevent erroneous frame processing in which the wrong output path is selected, unlike the related art.

In addition, since the active FPGA 2 issues the notification of the switching to the standby FPGA 3 after the processing of the last frame having the identifier added thereto is completed, it is possible to eliminate duplication of frames when the active FPGA 2 is switched to the standby FPGA 3.

What is claimed is:

1. A transmission apparatus terminating frames or packets, which are main signals supplied through a transmission path, the transmission apparatus comprising:
an active programmable device processing the main signals;
a standby programmable device in which a version of programming is being upgraded;
an external memory part that includes a table memory storing search tables used by the active and standby programmable devices to process the main signals and a main signal memory storing the main signals and that is shared between the active and standby programmable devices; and
a switching part that selects the main signal processed by the active programmable device before the version upgrade and selects the main signal processed by the standby programmable device after the version upgrade to transmit the selected main signal to an output path,
wherein the active programmable device is capable of processing the main signals in parallel with the main signals processed by the standby programmable device, and receives a notification of completion of the version upgrade from the standby programmable device to issue an instruction to start switching to the standby programmable device, and wherein the standby programmable device uses the table memory and the main signal memory in the external memory part, updated by the active programmable device, to process the main signals in response to the instruction to start the switching from the active programmable device.

2. The transmission apparatus according to claim 1,
wherein the active programmable device specifies a last main signal to be processed, along with the reception of the notification of completion of the version upgrade from the standby programmable device and the issuance of the instruction to start switching to the standby programmable device, and switches a switching signal to be supplied from the active programmable device to the switching part from enablement to disablement and issues a notification of switching to the standby programmable device after transmitting the processed main signals up to the last main signal to the switching part,
wherein the standby programmable device switches a switch signal to be supplied from the standby programmable device to the switching part from the disablement to the enablement after receiving the notification of switching, and
wherein the switching part performs the selection in accordance with the switching signals from the active programmable device and the standby programmable device.

3. The transmission apparatus according to claim 1,
wherein the external memory group includes a dynamic information memory storing dynamic information involved in the reception of the main signals, and
wherein the active programmable device updates the dynamic information memory for every processing unit of the main signals, and the standby programmable device that has completed the version upgrade refers to the dynamic information memory updated by the active programmable device to process the main signals.

4. The transmission apparatus according to claim 3,
wherein the dynamic information includes a memory structure of the main signal memory, which varies for every processing unit of the main signals, and statistical information including the number of received main signals and the number of discarded main signals.
